(19) United States
(12) Patent Application Publication
(10) Pub. No.: US 2017/0144278 A1
(43) Pub. Date: May 25, 2017

(54) IMPACT TOOL

(71) Applicant: HITACHI KOKI CO., LTD., Tokyo (JP)

(72) Inventors: Tomomasa NISHIKAWA, Ibaraki (JP); Tetsuhiro HARADA, Ibaraki (JP); Nobuhiro TAKANO, Ibaraki (JP); Satoru MATSUNO, Ibaraki (JP)

(73) Assignees: HITACHI KOKI CO., LTD., Tokyo (JP); HITACHI KOKI CO., LTD., Tokyo (JP)

(21) Appl. No.: 15/321,017

(22) PCT Filed: Jun. 19, 2015
(86) PCT No.: PCT/JP2015/067722

§ 371 Date: Dec. 21, 2016

(30) Foreign Application Priority Data
Jun. 30, 2014 (JP) 2014-135265
Jun. 30, 2014 (JP) 2014-135348

(51) Int. Cl. B25B 21/02

(52) U.S. Cl. CPC B25B 21/026

(57) ABSTRACT

In order to increase the screw tightening speed and improve the work efficiency, three first pawls 30e of a hammer 30 and three second pawls 18d of an anvil 18 are provided, so that a striking interval can be set to “interval of 120 degrees”, which is shorter than that of the related art. By setting total inertia obtained by sum of inertia of a rotor 12b and inertia of a spindle 26 to a low value which is “300 kg·mm²” or less when converted in terms of a rotation axis of the spindle 26, the rotor 12b and the spindle 26 can be sufficiently accelerated and the work efficiency can be improved.

### TECHNICAL FIELD

The present invention relates to an impact tool that applies a rotational force and a striking force to a tool tip.

### BACKGROUND ART

Patent Document 1 describes an example of an impact tool that applies a rotational force and a striking force to a tool tip. A screw tightening tool (impact tool) described in Patent Document 1 is provided with a spindle to which a rotational force of a motor (driving source) is transmitted and a hammer which is provided between the spindle and an anvil and converts a rotational force of the spindle into a striking force in a rotation direction of the anvil.

A pair of cam grooves is provided in each of an outer circumferential portion of the spindle and an inner circumferential portion of the hammer, and a cam ball (steel ball) is disposed between each of these cam grooves. In addition, two hammer convex portions (hammer pawls) are provided in the hammer on the side closer to the anvil at an interval of 180 degrees about the axis, and two anvil convex portions (anvil pawls) are provided in the anvil on the side closer to the hammer at an interval of 180 degrees about the axis. Further, the respective hammer convex portions and the respective anvil convex portions are engaged with each other, so that a rotational force of the hammer is transmitted to the anvil. Note that a bit (tool tip) is attached to the anvil on the side opposite to the hammer side in the axial direction of the anvil.

The rotational force of the motor is transmitted to the bit (tool tip) via the spindle, the cam ball, the hammer and the anvil. Further, when a predetermined load is applied to the bit, the cam ball rolls along the cam groove. Accordingly, the hammer is separated from the anvil against a spring force of a spring, and then, approaches toward the anvil by the spring force of the spring. At this time, the hammer relatively rotates with respect to the anvil when being separated from the anvil, and the hammer convex portion and the anvil convex portion are engaged with and impact each other when the hammer approaches the anvil. Repetitions of such opening and engagement between the hammer convex portion and the anvil convex portion generate the striking force in the rotation direction of the bit.

### RELATED ART DOCUMENTS

### Patent Documents

Patent Document 1: Japanese Patent Application Laid-Open Publication No. 2006-247792

### SUMMARY OF THE INVENTION

### Problems to be Solved by the Invention

However, since two hammer pawls and two anvil pawls are provided in the impact tool described in Patent Document 1 mentioned above, the hammer pawl and the anvil pawl are configured to impact each other every time when the hammer and the anvil relatively rotate by 180 degrees. Accordingly, it is difficult to respond to the need for improving the work efficiency by shortening a striking interval. Here, the improvement of the work efficiency by the shortening of the striking interval can be achieved by increasing the number of impacts (number of times of striking) between the hammer pawl and the anvil pawl per unit time.

Thus, it may be conceivable to increase the number of hammer pawls and the number of anvil pawls. For example, when the number of the hammer pawls and the number of the anvil pawls are four, respectively, it is possible to obtain twice the number of times of striking as compared to the above-described case in which each two hammer pawls and anvil pawls are provided. However, the following problem may arise in the case of simply increasing the number of the hammer pawls and the number of the anvil pawls.

That is, the striking interval is the “interval of 180 degrees” in the case of providing the respective two pawls, and it is possible to sufficiently accelerate a rotating body such as the spindle relative to the output of the motor between the initial striking and the next striking. On the other hand, the striking interval is an “interval of 90 degrees” in the case of providing the respective four pawls, and it is difficult to sufficiently accelerate a rotating body such as the spindle relative to the output of the motor between the initial striking and the next striking. This is because of the magnitude of inertia (moment of inertia) of the rotating body rotated by the motor, and eventually striking is started in a low-rotation region before the rotating body is sufficiently accelerated. Accordingly, a situation where the number of times of striking cannot be increased so much may occur due to the insufficient number of rotations even when the respective four pawls are provided.

In addition, the number of rotations of the anvil during non-striking of the hammer and the number of times of striking during striking of the hammer are set to substantially the same value in the impact tool described in Patent Document 1 mentioned above. To be specific, a ratio between the number of rotations of the anvil (during the non-striking) and the number of times of striking of the hammer (during the striking) is substantially “1:1” as illustrated in “comparative example A” and “comparative example B” in FIGS. 14 and 15. Accordingly, a primary vibration frequency (rotation frequency) generated due to imbalance of the center of gravity of a rotating body such as the anvil and a vibration frequency (impact frequency) generated due to the striking operation of the hammer become significantly similar values.

In this case, the rotation frequency during the non-striking and the impact frequency during the striking resonate with each other when the impact tool is transitioned from a non-striking state to a striking state, and this causes a problem that vibration (shaking) of the impact tool main body increases. Consequently, the sense of operation deteriorates as the stable operation of the impact tool is inhibited, the worker is likely to get tired, and further, there may occur a problem that the bit is easily detached from a screw during the screw tightening work.

Namely, there is no consideration on the problem that the tool tip is lifted and detached from the screw during the screw tightening work, particularly, in the initial stage of the screw tightening (screwing) in the impact tool described in Patent Document 1 mentioned above.

An object of the present invention is to provide an impact tool capable of increasing the speed of screw tightening and improving the work efficiency. In addition, another object of the present invention is to provide the impact tool capable of easily performing the screw tightening by suppressing a tool tip from being lifted and detached from a screw in an initial stage of the screw tightening.

### Means for Solving the Problems

In an aspect of the present invention, an impact tool that applies a rotational force and a striking force to a tool tip include: a driving source including a first rotating body; a second rotating body rotated by the first rotating body; an output member provided with the tool tip; a striking member which converts a rotational force of the second rotating body into a rotational force and a striking force of the output member; three first pawls disposed side by side in a circumferential direction in the striking member on a side closer to the output member; and three second pawls disposed side by side in a circumferential direction in the output member on a side closer to the striking member and engaged with the first pawls, respectively, and a total inertia obtaining by sum of inertia of the first rotating body and inertia of the second rotating body is set to be equal to or less than 300 kg·mm² when being converted in terms of a rotation axis of the second rotating body.

In another aspect of the present invention, the first pawls and the second pawls are disposed at an interval of 120 degrees along the circumferential direction of each of the striking member and the output member.

In another aspect of the present invention, the number of times of striking of the striking member is set to 4,000 times/minute or larger.

In another aspect of the present invention, an impact tool that applies a rotational force and a striking force to a tool tip includes: an electric motor including a rotor; a spindle rotated by the rotor; an anvil provided with the tool tip; and a hammer which converts a rotational force of the spindle into a rotational force and a striking force of the anvil, and the number of times of striking of the hammer is set to 4,000 times/minute or larger.

In another aspect of the present invention, the impact tool further includes: three first pawls disposed side by side in a circumferential direction in the hammer on a side closer to the anvil; and three second pawls disposed side by side in a circumferential direction in the anvil on a side closer to the hammer and engaged with the first pawls, respectively.

In another aspect of the present invention, a total inertia obtaining by sum of inertia of the rotor and inertia of the spindle is set to be equal to or less than 300 kg·mm² when being converted in terms of a rotation axis of the spindle.

In another aspect of the present invention, an impact tool includes: a motor; an anvil rotated by the motor to rotate a tool tip; and a hammer applying a striking force to the anvil, a controller which controls the motor is provided, and the controller is configured to increase a voltage applied to the motor when detecting striking of the hammer.

In another aspect of the present invention, the number of times of striking of the hammer is set to 4,000 times/minute or larger.

In another aspect of the present invention, first pawls are provided in the anvil, second pawls are provided in the hammer, the striking force is generated when the first pawls and the second pawls impact each other in a rotation direction, and the number of the first pawls and the number of the second pawls are three, respectively.

In another aspect of the present invention, an impact tool includes: a rotating body which rotates a tool tip; and a striking member which applies a striking force to the tool tip, and a ratio between the number of rotations of the rotating body during non-striking of the striking member and the number of times of striking during striking of the striking member is 1:1.3 or higher.

In another aspect of the present invention, the number of times of striking is 4,000 times/minute or larger.

In another aspect of the present invention, a driving source of the rotating body is a brushless motor, a controller which controls the brushless motor is provided, and the controller increases a voltage to be applied to the brushless motor when detecting striking of the striking member.

In another aspect of the present invention, first pawls are provided in the rotating body, second pawls are provided in the striking member, the striking force is generated when the first pawls and the second pawls impact each other in a rotation direction, and the number of the first pawls and the number of the second pawls are three, respectively.

In another aspect of the present invention, an impact tool includes: an anvil including first pawls and rotating a tool tip; and a hammer including second pawls which impact the first pawls in a rotation direction and applying a striking force generated by the impact to the anvil, the number of the first pawls and the number of the second pawls are three, respectively, and a ratio between the number of rotations of the anvil during non-striking of the hammer and the number of times of striking during striking of the hammer is set to 1:1.3 or higher.

In another aspect of the present invention, the number of times of striking is 4,000 times/minute or larger.

### Effects of the Invention

According to the present invention, it is possible to increase the speed of screw tightening and improve the work efficiency. In addition, according to the present invention, it is possible to perform the fast screw tightening while suppressing come-out in the initial stage of the screw tightening.

### BRIEF DESCRIPTIONS OF THE DRAWINGS

FIG. 1 is a perspective view illustrating an impact tool according to the present invention;

FIG. 2 is a partial cross-sectional view of the impact tool of FIG. 1;

FIG. 3 is a cross-sectional view illustrating an electric motor, a decelerator, and a striking mechanism;

FIG. 4 is an exploded perspective view illustrating the striking mechanism (three-pawl specification);

FIG. 5 is an exploded perspective view illustrating the striking mechanism (two-pawl specification);

FIG. 6 is a graph for describing a rising time of the number of rotations of a rotating body;

FIG. 7 is a graph for describing the number of times of striking (two-pawl specification);

FIG. 8 is a graph for describing the number of times of striking (three-pawl specification);

FIG. 9 is a graph illustrating a relationship between the total inertia and the tightening speed;

FIG. 10 is a graph for comparing the present invention and four comparative examples A to D;

FIG. 11 is an electric circuit block diagram of the impact tool of FIG. 1;

FIG. 12 is a flowchart for describing an operation of the impact tool of FIG. 1;

FIG. 13 is a timing chart for describing the operation of the impact tool of FIG. 1;

FIG. 14 is a table for comparing the present invention and the four comparative examples A to D; and

FIG. 15 is a graph for comparing the present invention and the four comparative examples A to D.

### DETAILED DESCRIPTION OF PREFERRED EMBODIMENTS

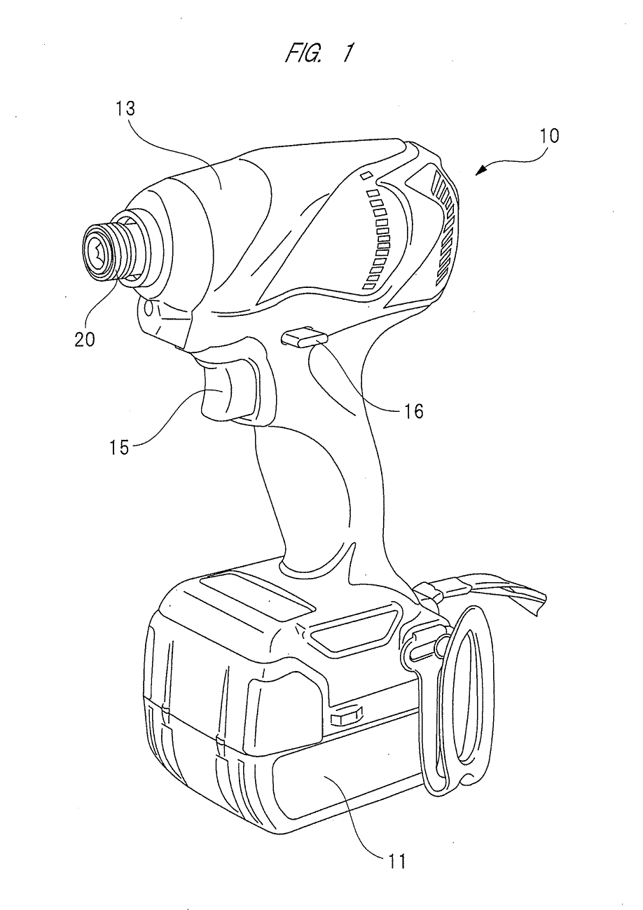

Hereinafter, the first embodiment of the present invention will be described in detail with reference to the drawings (FIGS. 1 to 11).

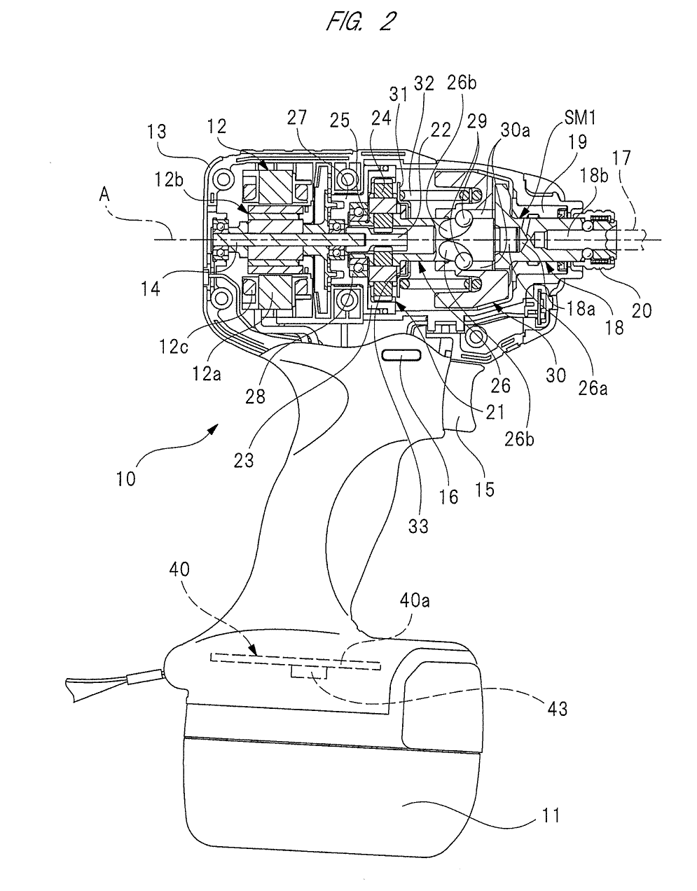

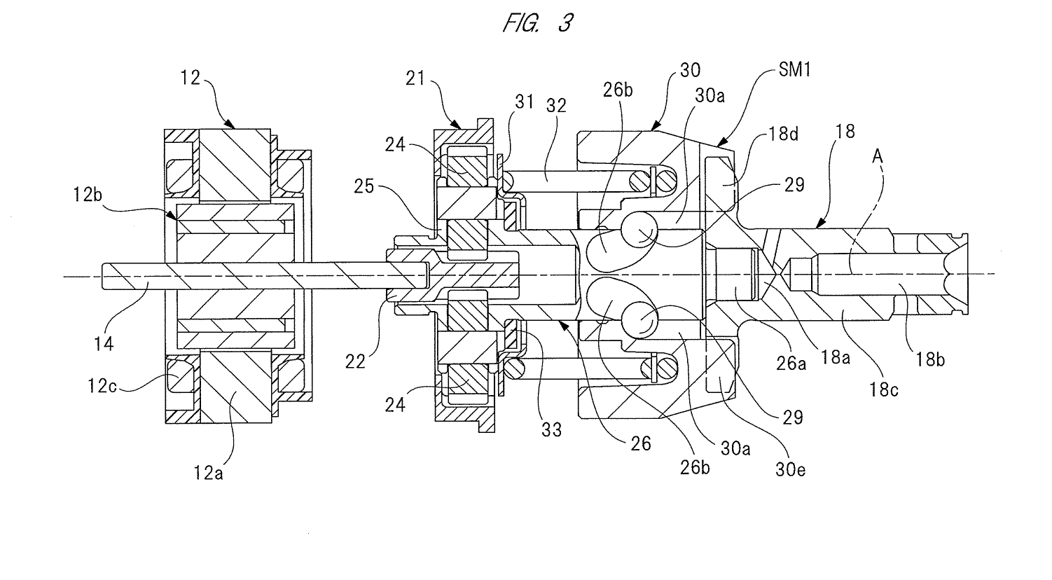

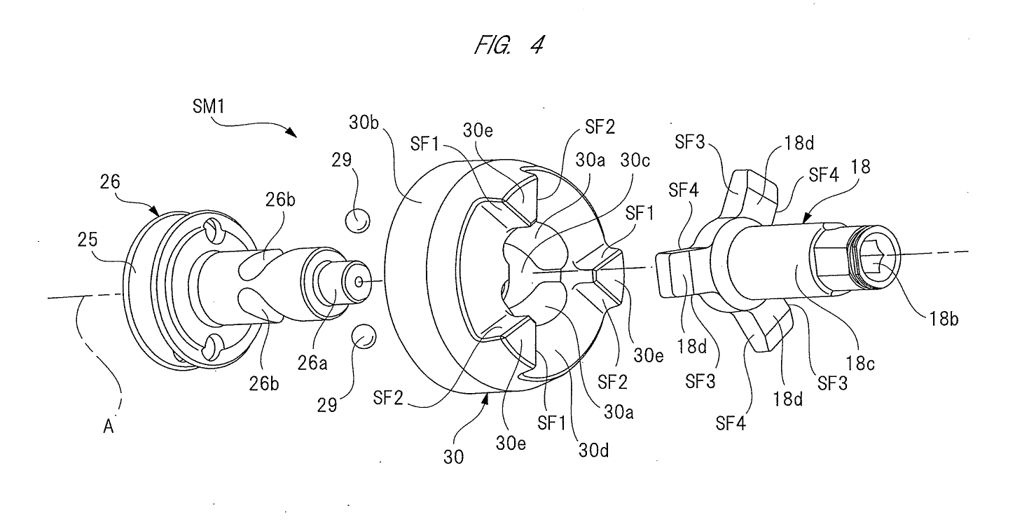

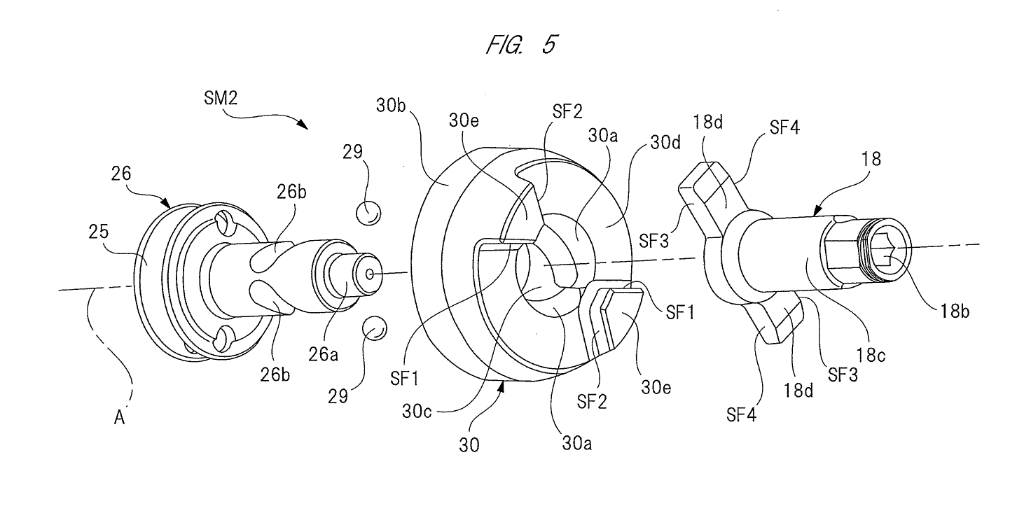

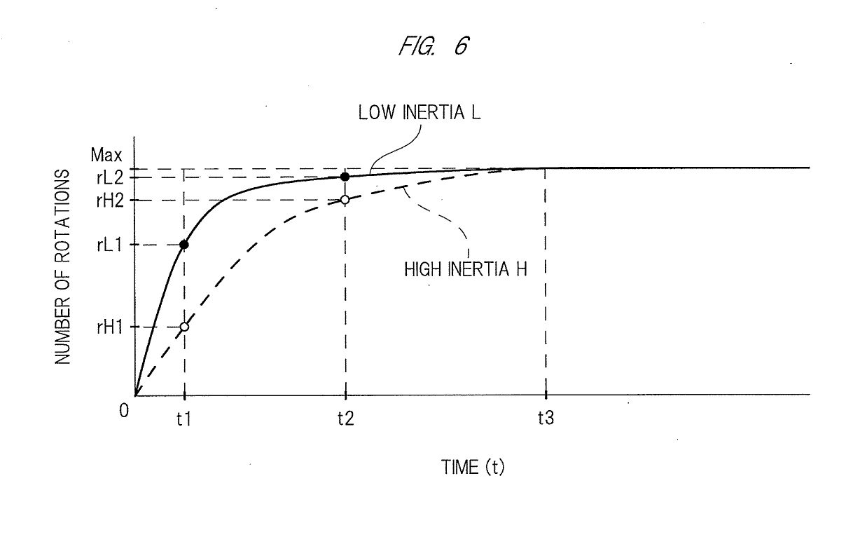

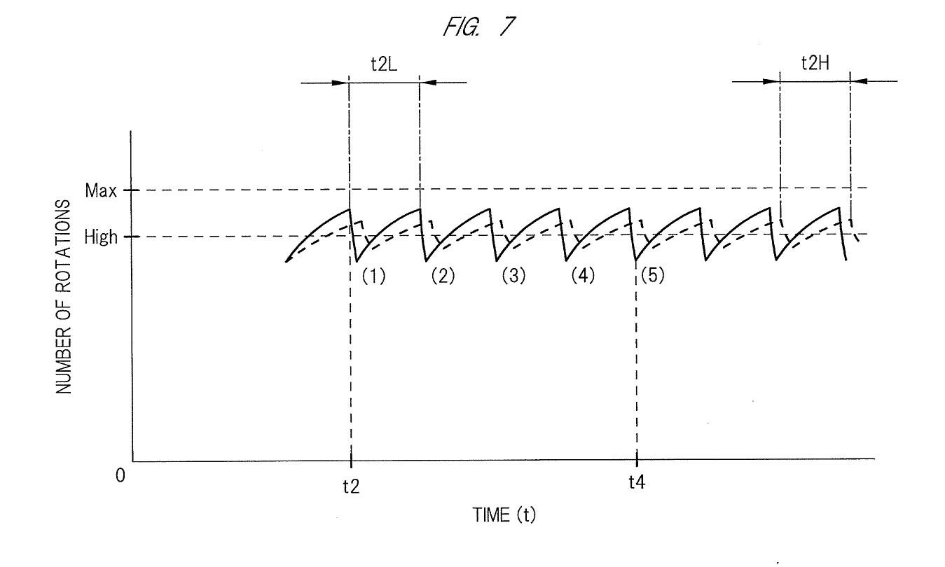

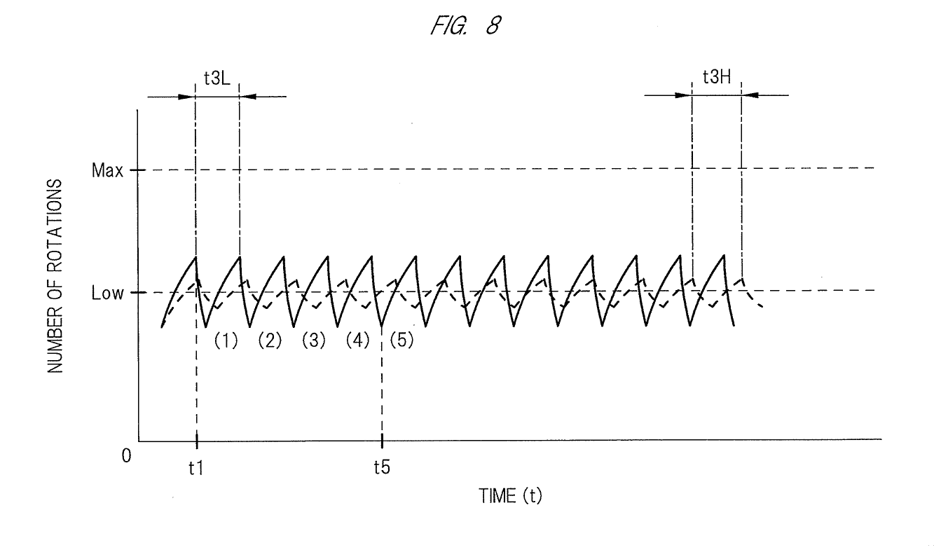

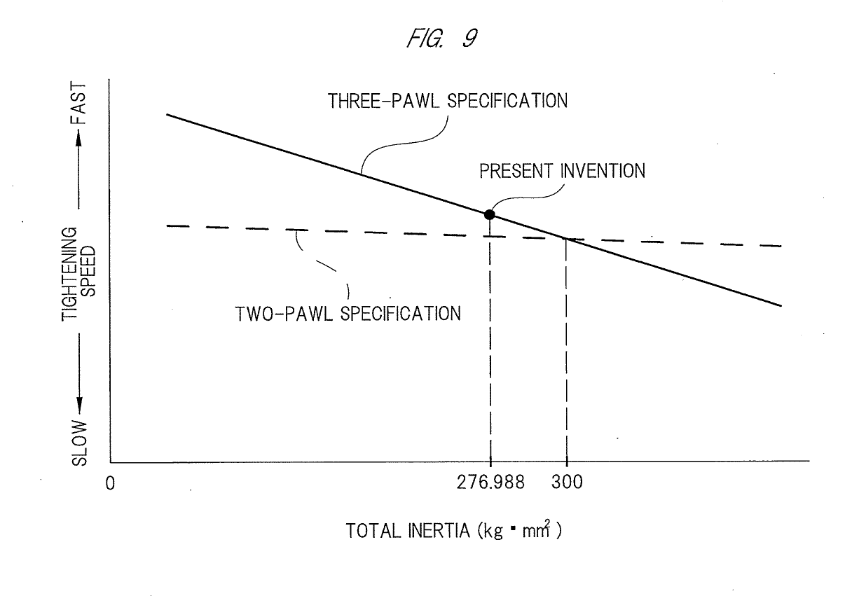

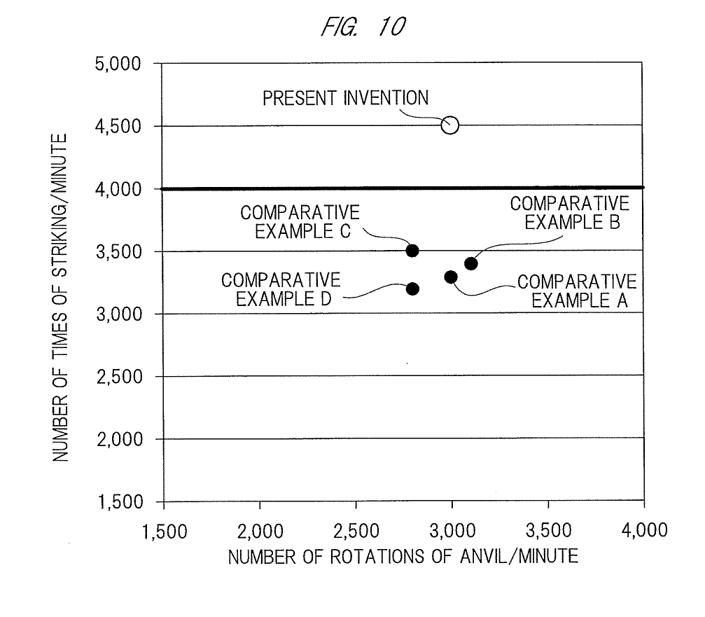

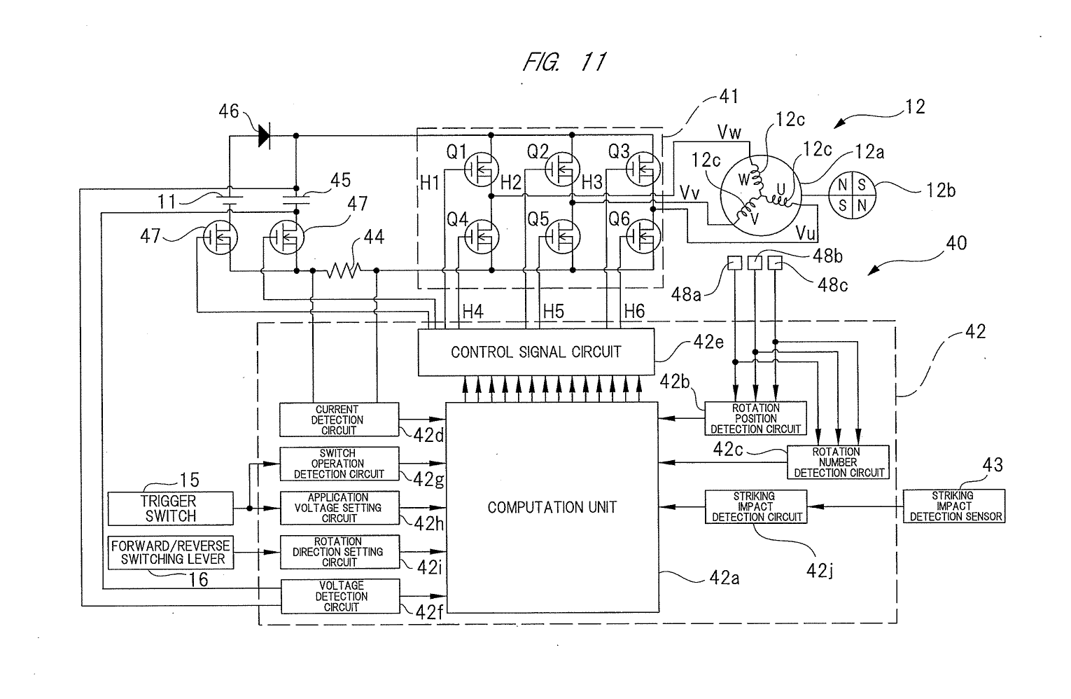

FIG. 1 is a perspective view illustrating an impact tool according to the present invention, FIG. 2 is a partial cross-sectional view of the impact tool of FIG. 1, FIG. 3 is a cross-sectional view illustrating an electric motor, a decelerator, and a striking mechanism, FIG. 4 is an exploded perspective view illustrating the striking mechanism (three-pawl specification) of the present invention, FIG. 5 is an exploded perspective view illustrating the striking mechanism (two-pawl specification) of a comparative example, FIG. 6 is a graph for describing a rising time of the number of rotations of a rotating body, FIG. 7 is a graph for describing the number of times of striking (two-pawl specification) of a comparative example, FIG. 8 is a graph for describing the number of times of striking (three-pawl specification) of the present invention, FIG. 9 is a graph illustrating a relationship between the total inertia and the tightening speed, FIG. 10 is a graph for comparing the present invention and four comparative examples A to D, and FIG. 11 is an electric circuit block diagram of the impact tool of FIG. 1.

As illustrated in FIGS. 1 to 3, an impact driver 10 serving as the impact tool includes a battery pack 11 in which a chargeable and dischargeable battery cell is housed and an electric motor 12 which is driven by power supplied from the battery pack 11. The electric motor 12 is a driving source that converts electric energy into kinetic energy. The impact driver 10 is provided with a casing 13 made of plastic or the like, and the electric motor 12 is provided inside the casing 13.

The electric motor 12 is a brushless motor and is provided with a stator (stationary member) 12a formed in an annular shape and a rotor (rotating member) 12b formed in a cylindrical shape. The rotor 12b forms a first rotating body according to the present invention and is configured to rotate about an axis A on the radially inner side of the stator 12a. In this manner, an inner rotor brushless motor is employed as the electric motor 12.

The stator 12a is fixed to the casing 13, and a coil 12c is wound around the stator 12a by a predetermined winding method. The rotor 12b is formed of a plurality of permanent magnets magnetized along the circumferential direction, and is provided to be freely rotatable on the radially inner side of the stator 12a with a minute gap (air gap) interposed therebetween. Accordingly, by supplying a driving current to the coil 12c, the rotor 12b rotates in a predetermined rotation direction at a predetermined rotation speed.

A rotation shaft 14 which rotates about the axis A is provided at the center of rotation of the rotor 12b in an integrated manner. The rotation shaft 14 rotates in the forward direction or the reverse direction through the operation of a trigger switch 15. Namely, power is supplied from the battery pack 11 to the electric motor 12 through the operation of the trigger switch 15. Here, the rotation direction of the rotation shaft 14 is switched by operating a forward/reverse switching lever 16 provided in the vicinity of the trigger switch 15.

The impact driver 10 includes an anvil (an output member or a rotating body) 18 in which a tool tip 17 such as a driver bit is provided. The anvil 18 is supported to be freely rotatable by a sleeve 19 mounted inside the casing 13. Note that the inside of the sleeve 19 is coated with grease (not illustrated) that makes the rotation of the anvil 18 smooth. Further, the anvil 18 rotates about the axis A, and the tool tip 17 is mounted to a tip portion of the anvil 18 via an attaching/detaching mechanism 20.

A decelerator 21 is provided between the electric motor 12 and the anvil 18 in a direction along the axis A inside the casing 13. The decelerator 21 is a power transmission device that increases (amplifies) a torque of a rotational force of the electric motor 12 and transmits the resultant to the anvil 18, and is a so-called single-pinion planetary gear mechanism. The decelerator 21 includes a sun gear 22 disposed coaxially with the rotation shaft 14, a ring gear 23 disposed so as to surround the sun gear 22, a plurality of planetary gears 24 meshing with both the sun gear 22 and the ring gear 23, and a carrier 25 which supports each of the planetary gears 24 so as to be rotatable and revolvable. Further, the ring gear 23 is fixed to the casing 13 via a holder member 27 described later so as to be non-rotatable.

A spindle (second rotating body) 26 which rotates about the axis A together with the carrier 25 is provided in the carrier 25 in an integrated manner. Namely, the rotation shaft 14 of the electric motor 12, the decelerator 21, the spindle 26, and the anvil 18 are disposed coaxially with each other around the axis A. The spindle 26 is provided between the anvil 18 and the decelerator 21 in the direction along the axis A, and a shaft 26a which protrudes in the direction along the axis A is formed at a tip portion of the spindle 26 on the side closer to the anvil 18.

The holder member 27 formed in a substantially bowl shape is provided inside the casing 13 between the electric motor 12 and the decelerator 21 in the direction along the axis A. A bearing 28 is mounted to a center portion of the holder member 27, and the bearing 28 supports a proximal portion of the spindle 26 on the side closer to the electric motor 12 so as to be freely rotatable. In addition, a pair of groove-shaped spindle cams 26b is provided around the spindle 26 on the side closer to the anvil 18. A part of a steel ball 29 enters inside each of the spindle cams 26b.

A holding hole 18a coaxial with the axis A is provided in a proximal portion of the anvil 18 on the side closer to the spindle 26. The shaft 26a of the spindle 26 is inserted into the holding hole 18a so as to be freely rotatable. Namely, the anvil 18 and the spindle 26 are relatively rotatable about the axis A. Note that grease (not illustrated) is applied also between the shaft 26a and the holding hole 18a so as to make the relative rotation smooth. In addition, a mounting hole 18b is provided in the anvil 18 coaxially with the axis A. The mounting hole 18b is opened toward the outside of the casing 13 and is provided in order to attach and detach a proximal portion of the tool tip 17.

A hammer (striking member) 30 formed in a substantially annular shape is provided around the spindle 26. The hammer 30 is disposed between the decelerator 21 and the anvil 18 in the direction along the axis A. The hammer 30 is relatively rotatable with respect to the spindle 26 and is relatively movable in the direction along the axis A. A pair of groove-shaped hammer cams 30a extending in the direction along the axis A is formed on the radially inner side of the hammer 30. A part of the steel ball 29 enters inside each of the hammer cams 30a.

In this manner, one of the two steel balls 29 is held by one of the two spindle cams 26b and one of the hammer cams 30a as a set. In addition, the other of the two steel balls 29 is held by the other of the two spindle cams 26b and the other of the hammer cams 30a as a set. Here, the steel ball 29 is configured of a metallic rolling body. Thus, the hammer 30 is movable with respect to the spindle 26 in the direction along the axis A within a range in which the steel ball 29 can be rolled. In addition, the hammer 30 is movable with respect to the spindle 26 in the circumferential direction about the axis A within the range in which the steel ball 29 can be rolled.

An annular plate 31 made of a steel plate is provided around the spindle 26 between the decelerator 21 and the hammer 30 in the direction along the axis A. In addition, a spring 32 is provided in the state of being compressed between the annular plate 31 and the hammer 30 in the direction along the axis A. The movement of the carrier 25 in the direction along the axis A is regulated as being in contact with the bearing 28 and the holder member 27, and a pressing force of the spring 32 is applied to the hammer 30. Accordingly, the hammer 30 is pressed toward the anvil 18 in the direction along the axis A by the pressing force of the spring 32.

An annular stopper 33 is provided around the spindle 26 and on the radially inner side of the annular plate 31. The stopper 33 is formed of an elastic body such as rubber and is attached to the spindle 26. Further, the stopper 33 is configured to regulate the amount of movement of the hammer 30 toward the decelerator 21 along the axis A.

Here, a striking mechanism SM1 which applies a striking force to the tool tip 17 is formed of the spindle 26, the hammer 30, the anvil 18, the steel ball 29, and the spring 32. Further, when a load in the rotation direction of the anvil 18 increases, first pawls 30e of the hammer 30 and second pawls 18d of the anvil 18 are repeatedly opened and engaged with each other at high speed, and thus a rotational striking force is generated at the tool tip 17. Here, the weight of the hammer 30 is set to be larger than the weight of the anvil 18, and the hammer 30 converts the rotational force of the spindle 26 into a rotational force of the anvil 18 and a striking force of the anvil 18 in the rotation direction. However, the weight of the hammer 30 may be set to be smaller than the weight of the anvil 18.

Next, the engagement structure between the hammer 30 and the anvil 18 will be described in detail with reference to FIG. 4.

The hammer 30 is provided with a main body 30b formed in a substantially cylindrical shape, and a mounting hole 30c which extends in the direction along the axis A and to which the spindle 26 is rotatably mounted is provided on the radially inner side of the main body 30b. The main body 30b has a tapered shape on the side closer to the anvil 18. Namely, the main body 30b has a large diameter on, the side closer to the spindle 26, and the main body 30b has a small diameter on the side closer to the anvil 18. Here, a diameter size of the main body 30b on the side closer to the spindle 26 (the side with the large diameter) is set to about 40 mm.

An opposing plane 30d opposed to the anvil 18 is provided in the main body 30b on the side closer to the anvil 18. Three first pawls (hammer pawls) 30e which protrude in the direction along the axis A toward the anvil 18 are provided on the opposing plane 30d in an integrated manner. These first pawls 30e are disposed side by side at an interval of 120 degrees (equal interval) along the circumferential direction of the opposing plane 30d, and each cross-sectional shape thereof along a direction intersecting the axis A is a substantially sector shape. Further, a tapered tip side of the first pawl 30e, that is, the radially inner side of the sector shape is directed to the radially inner side of the hammer 30, that is, the mounting hole 30c.

A first contact plane SF1 is provided on one side of the first pawl 30e in the circumferential direction of the hammer 30. In addition, a second contact plane SF2 is provided on the other side of the first pawl 30e in the circumferential direction of the hammer 30. Further, each of fourth contact planes SF4 of the second pawls 18d of the anvil 18 is in contact with each of the first contact planes SF1 on the substantially entire surface, and each of third contact planes SF3 of the second pawls 18d of the anvil 18 is in contact with each of the second contact planes SF2 on the substantially entire surface.

In addition, a width size of the first pawl 30e in a direction along the circumferential direction on the radially outer side of the hammer 30 is set to about 10 mm. Accordingly, the strength of the first pawl 30e is sufficiently secured, and the second pawl 18d of the anvil 18 enters between the first pawls 30e neighboring in the circumferential direction of the hammer 30 with a margin.

The anvil 18 is provided with a main body 18c formed in a substantially cylindrical shape. Three second pawls (anvil pawls) 18d which protrude toward the radially outer side are provided in an integrated manner in the main body 18c on the side closer to the hammer 30 in the axial direction. These second pawls 18d are disposed side by side at an interval of 120 degrees (equal interval) along the circumferential direction of the main body 18c, and each cross-sectional shape thereof along a direction intersecting the axis A is a substantially rectangular shape.

The third contact plane SF3 is provided on one side of the second pawl 18d in the circumferential direction of the anvil 18. In addition, the fourth contact plane SF4 is provided on the other side of the second pawl 18d in the circumferential direction of the anvil 18. Further, each of the second contact planes SF2 of the first pawls 30e of the hammer 30 is in contact with each of the third contact planes SF3 on the substantially entire surface, and each of the first contact planes SF1 of the first pawls 30e of the hammer 30 is in contact with each of the fourth contact planes SF4 on the substantially entire surface.

In addition, a width size of the second pawl 18d in a direction along the circumferential direction on the radially outer side of the anvil 18 is set to about 9 mm. Namely, the second pawl 18d is designed to have the slightly smaller width size than the first pawl 30e. Accordingly, the strength of the second pawl 18d is sufficiently secured, and a distance between the second pawls 18d neighboring in the circumferential direction of the anvil 18 is set to be relatively long, so that the first pawl 30e of the hammer 30 enters therebetween with a margin.

Here, in a state where the first pawl 30e of the hammer 30 and the second pawl 18d of the anvil 18 are engaged with each other in the forward rotation direction (screw-tightening direction), the first contact surface SF1 of the first pawl 30e and the fourth contact plane SF4 of the second pawl 18d are in contact with each other on the substantially entire surface. Further, when the hammer 30 performs a striking operation (during the striking), the three first contact surfaces SF1 and the three fourth contact planes SF4 impact each other and are opened substantially at the same time. Since the three first pawls 30e and the three second pawls 18d are provided in the hammer 30 and the anvil 18, respectively, as described above, the number of times of striking (simultaneous striking) is three when the hammer 30 and the anvil 18 relatively rotate once.

Note that, when the forward/reverse switching lever 16 (see FIG. 2) is operated, the first pawl 30e of the hammer 30 and the second pawl 18d of the anvil 18 are engaged with each other in the reverse rotation direction (screw-loosening direction). Therefore, the second contact surface SF2 of the first pawl 30e and the third contact plane SF3 of the second pawl 18d are in contact with each other on the substantially entire surface. Accordingly, the striking force is applied in the reverse rotation direction, and it is possible to loosen a tightened screw (not illustrated).

As illustrated in FIG. 2, the impact driver 10 is controlled by a controller 40 that is housed in a portion of the casing 13 to which the battery pack 11 is mounted (battery pack mounting portion at the lower part of the drawing). Hereinafter, an electric circuit of the impact driver 10 will be described in detail with reference to the drawings.

As illustrated in FIG. 11, the controller 40 is provided with an inverter unit 41 including six switching elements (FET) Q1 to Q6 and a control unit 42 including a computation unit 42a and a plurality of other electric circuits, and these are mounted to a substrate 40a. Further, the respective coils 12c (a U-phase, a V-phase, and a W-phase) of the electric motor 12 are electrically connected to the inverter unit 41, and signals are input to the control unit 42 from the trigger switch 15, the forward/reverse switching lever 16, a striking impact detection sensor 43, and three Hall elements 48a, 48b and 48c.

The electric motor 12 is an inner rotor brushless motor and is provided with a rotor 12b including a plurality of sets of an N-pole and an S-pole, the stator 12a around which the coils 12c formed of the U-phase, the V-phase and the W-phase (three phases) which are star connected are wound, and the three Hall elements 48a, 48b and 48c disposed at a predetermined interval (for example, an interval of 60 degrees) in the circumferential direction of the stator 12a in order to detect a rotation state of the rotor 12b. Note that it is also possible to provide the Hall elements 48a to 48c in a sensor substrate which is fixed to an end of the stator 12a so as to be substantially orthogonal to the rotation shaft 14 of the electric motor 12, and further, it is also possible to provide the switching elements Q1 to Q6 of the inverter unit 41 in the sensor substrate.

A detection signal from each of the Hall elements 48a to 48c is input to a rotation position detection circuit 42b and a rotation number detection circuit 42c of the control unit 42. Further, rotation position data of the rotor 12b is output from the rotation position detection circuit 42b to the computation unit 42a. In addition, rotation number data of the rotor 12b is output from the rotation number detection circuit 42c to the computation unit 42a. Accordingly, the computation unit 42a recognizes a present rotation state of the electric motor 12 and controls a subsequent rotation state of the electric motor 12 based on the present rotation state.

A current detection circuit 42d which detects a current value flowing in the inverter unit 41 is provided in the control unit 42, and the current detection circuit 42d is electrically connected to both ends of a current detection resistor 44. Accordingly, the present current value being supplied to the electric motor 12 is fed back to the computation unit 42a. Further, the computation unit 42a controls a control signal circuit 42e to perform emergency stop (fail-safe operation) or the like in order to protect the electric motor 12 when overcurrent in the electric motor 12 due to an increase of a load applied to the electric motor 12 or the like is detected.

A voltage detection circuit 42f which detects a voltage of the battery pack 11 is provided in the control unit 42, and the voltage detection circuit 42f is electrically connected to both ends of a capacitor 45, for example. Accordingly, the present capacity of the battery pack 11 is fed back to the computation unit 42a. Further, the computation unit 42a turns on, for example, a battery warning light (not illustrated) when the remaining capacity of the battery pack 11 is small. On the other hand, the computation unit 42a turns on, for example, a battery charged light (not illustrated) when the remaining capacity of the battery pack 11 is large. Note that the voltage of the battery pack 11 may be detected by detecting voltages at both ends of the battery pack 11 itself, and in this case, the voltage detection circuit 42f is electrically connected to both the ends of the battery pack 11. The capacitor 45 has a function of suppressing high current from the battery pack 11 from flowing into the inverter unit 41 during a switching operation of the inverter unit 41.

The trigger switch 15 generates a voltage signal which changes in proportion to the amount of operation. The voltage signal of the trigger switch 15 is input to a switch operation detection circuit 42g and an application voltage setting circuit 42h of the control unit 42. The switch operation detection circuit 42g receives the voltage signal from the trigger switch 15 and outputs, to the computation unit 42a, start data indicating that the trigger switch 15 has been operated. Accordingly, the computation unit 42a recognizes that the impact driver 10 has been operated.

Meanwhile, the application voltage setting circuit 42h adjusts the voltage signal from the trigger switch 15 to generate operation amount data, and outputs the operation amount data to the computation unit 42a. Namely, the operation amount data to be output to the computation unit 42a is small when the trigger switch 15 has been slightly operated by a worker, and the operation amount data to be output to the computation unit 42a is large when the trigger switch 15 has been greatly operated by a worker.

A switching signal from the forward/reverse switching lever 16 is input to a rotation direction setting circuit 42i of the control unit 42, and forward rotation data or reverse rotation data is output from the rotation direction setting circuit 42i to the computation unit 42a. The computation unit 42a drives the rotor 12b to rotate in the forward direction or the reverse direction based on the forward rotation data or the reverse rotation data.

The inverter unit 41 is provided with the six switching elements Q1 to Q6 which are electrically connected in a three-phase bridge configuration, and each gate of the switching elements Q1 to Q6 is electrically connected to the control signal circuit 42e of the control unit 42. In addition, each drain or each source of the switching elements Q1 to Q6 is electrically connected to each of the U-phase, V-phase and W-phase coils 12c. Accordingly, each of the switching elements Q1 to Q6 performs the switching operation in accordance with drive signals H1 to H6 from the control signal circuit 42e. Further, it is configured such that a DC voltage of the battery pack 11 applied to the inverter unit 41 is set to three-phase voltages Vu, Vv and Vw, and power is supplied to each of the coils 12c.

The computation unit 42a performs a process of changing each of the drive signals H1 to H6 which drives each gate of the switching elements Q1 to Q6 into a pulse width modulation signal (PWM signal). Further, the computation unit 42a supplies each of the drive signals H1 to H6 changed into the PWM signal to each of the switching elements Q1 to Q6 via the control signal circuit 42e. Namely, the computation unit 42a changes a duty ratio (pulse width) of the PWM signal based on the operation amount data proportional to the operation amount of the trigger switch 15. Accordingly, the amount of power (application voltage) to be supplied to the electric motor 12 is adjusted, and the drive and stop of the electric motor 12 and the rotation speed thereof are controlled.

The control unit 42 is provided with a striking impact detection circuit 42j to which a vibration signal from the striking impact detection sensor 43 is input. Note that the striking impact detection sensor 43 is configured of an acceleration sensor which is mounted to the substrate 40a (see FIG. 2) of the controller 40. The striking impact detection sensor 43 outputs the vibration signal when the impact driver 10 (the casing 13) vibrates. Further, the striking impact detection circuit 42j reads out the high-frequency vibration signal caused by striking of the hammer 30 (see FIG. 3), and outputs, to the computation unit 42a, a striking state signal indicating that the hammer 30 is striking. Further, the computation unit 42a performs the control to change the duty ratio of the PWM signal, that is, the pulse width of the PWM signal based on the input of the striking state signal.

Here, since each of the switching elements Q1 to Q6 of the inverter unit 41 performs the switching operation at high speed, an electrical noise is likely to be generated in the electric circuit forming the controller 40. Therefore, the controller 40 is provided with a noise reduction diode 46. Here, the noise reduction diode 46 not only functions as a flywheel diode but also serves a role of increasing energy efficiency to achieve the smooth motion of the electric motor 12.

In addition, a pair of switching elements 47 for stopping the controller is provided to prevent the power from being supplied to the controller 40 at the time of stopping the impact driver 10. Namely, the switching element 47 for stopping the controller has a function of suppressing wasteful power consumption and increasing the usable time of the battery pack 11.

Next, a basic operation of the impact driver 10 will be described.

When the electric motor 12 is stopped, the hammer 30 pressed by the spring 32 stops being in contact with the anvil 18. When the rotation shaft 14 rotates as power is supplied to the electric motor 12, the rotational force of the rotation shaft 14 is transmitted to the sun gear 22 of the decelerator 21. Then, the rotational force transmitted to the sun gear 22 is increased in torque, and is output from the carrier 25.

When the rotational force is transmitted to the carrier 25, the spindle 26 rotates. The rotational force of the spindle 26 is transmitted to the hammer 30 via the steel ball 29. The rotational force of the hammer 30 is transmitted to the anvil 18 through the engagement between the three first pawls 30e and the three second pawls 18d, and accordingly, the anvil 18 rotates. The rotational force transmitted to the anvil 18 is transmitted to a screw (not illustrated) via the tool tip 17, so that the screw is screwed into a wood or the like.

In a state where a rotational force required for rotation of the tool tip 17 is small, that is, a low-load state, the first contact plane SF1 of the first pawl 30e and the fourth contact plane SF4 of the second pawl 18d are in contact with each other. Thereafter, when the screw is screwed into a wood or the like and the rotational force (torque) required for rotation of the tool tip 17 increases, the rotation of the anvil 18 stops. Accordingly, each of the steel balls 29 rolls inside each of the hammer cams 30a and each of the spindle cams 26b, and the hammer 30 moves along the axis A so as to be separated from the anvil 18.

Accordingly, the first pawl 30e and the second pawl 18d are disengaged and released from each other, and the rotational force of the hammer 30 is no longer transmitted to the anvil 18. Thereafter, an end of the hammer 30 on the side closer to the electric motor 12 impacts the stopper 33, and kinetic energy of the hammer 30 is absorbed by the stopper 33.

Thereafter, when the rotation of the hammer 30 further continues and the first pawl 30e rides over the second pawl 18d, a force of the spring 32 pressing the hammer 30 increases. Accordingly, each of the steel balls 29 rolls inside each of the hammer cams 30a and each of the spindle cams 26b, and the hammer 30 moves so as to approach the anvil 18 while performing relative rotation.

Thereafter, each of the first pawls 30e of the rotating hammer 30 impacts each of the second pawls 18d of the stationary anvil 18 at the same time, and a striking force is applied in the rotation direction of the anvil 18 and the tool tip 17. Here, when the forward/reverse switching lever 16 (see FIG. 2) is operated to reverse the rotation direction of the electric motor 12, the striking force is applied in the reverse direction to that in the above-described operation. Accordingly, it is possible to loosen a tightened screw.

Next, the magnitude of inertia of the rotating body forming the impact driver 10 will be described.

Inertia RI of the rotor 12b serving as the first rotating body is set to “3.932 kg·mm²”, inertia SI of the spindle 26 serving as the second rotating body is set to “7.026 kg·mm²”, and a gear ratio GR of the decelerator 21 is set to “8.286”. Further, total inertia TI of the inertia RI of the rotor 12b and the inertia SI of the spindle 26 becomes “276.988 kg·mm²” when being converted in terms of the rotation axis of the spindle 26, and is set to “300 kg·mm²” or less (see FIG. 9).

Here, the total inertia TI (converted in terms of the rotation axis of the spindle 26) of the inertia RI of the rotor 12b and the inertia SI of the spindle 26 is obtained by substituting the above-described various parameters into the following Formula 1.

TI=SI+GR²×RI (Formula 1)

Next, a description will be given that work efficiency is improved more in a striking mechanism SM1 than in a striking mechanism SM2 (structure to be described later) by comparing the striking mechanism SM1 (three-pawl specification) of the impact driver 10 according to the present embodiment and the striking mechanism SM2 (two-pawl specification) of an impact driver (not illustrated) according to a comparative example. Note that the striking mechanism SM2 according to the comparative example is different from the striking mechanism SM1 according to the present invention only in that the two first pawls 30e and the two second pawls 18d are provided as illustrated in FIG. 5. Thus, the same reference characters as those in the striking mechanism SM1 illustrated in FIG. 4 are given in the striking mechanism SM2 illustrated in FIG. 5 in order to make the description easily understood. Here, the striking mechanism SM2 will be described before the comparison between the striking mechanism SM1 and the striking mechanism SM2.

As illustrated in FIG. 5, an opposing surface 30d opposed to the anvil 18 is provided in the main body 30b on the side closer to the anvil 18. Two first pawls (hammer pawls) 30e which protrude in the direction along the axis A toward the anvil 18 are provided on the opposing surface 30d in an integrated manner. These first pawls 30e are disposed to oppose each other about the axis A as the center at an interval of 180 degrees along the circumferential direction of the opposing surface 30d, and each cross-sectional shape thereof along a direction intersecting the axis A is a substantially sector shape. Further, a tapered tip side of the first pawl 30e, that is, the radially inner side of the sector shape is directed to the radially inner side of the hammer 30, that is, the mounting hole 30c.

A first contact surface SF1 is provided on one side of the first pawl 30e in the circumferential direction of the hammer 30. In addition, a second contact surface SF2 is provided on the other side of the first pawl 30e in the circumferential direction of the hammer 30. Further, a fourth contact plane SF4 of the second pawl 18d of the anvil 18 is in contact with the first contact surface SF1 on the substantially entire surface, and a third contact plane SF3 of the second pawl 18d of the anvil 18 is in contact with the second contact surface SF2 on the substantially entire surface.

In addition, a width size of the first pawl 30e in a direction along the circumferential direction on the radially outer side of the hammer 30 is set to about 15.0 mm. Accordingly, the strength of the first pawl 30e is sufficiently secured, and the second pawl 18d of the anvil 18 enters between the first pawls 30e neighboring in the circumferential direction of the hammer 30 with a margin.

The anvil 18 is provided with a main body 18c formed in a substantially cylindrical shape, and two second pawls (anvil pawls) 18d which protrude toward the radially outer side are provided in an integrated manner in the main body 18c on the side closer to the hammer 30 in the axial direction. These second pawls 18d are disposed to oppose each other about the axis A as the center at an interval of 180 degrees along the circumferential direction of the main body 18c, and each cross-sectional shape thereof along a direction intersecting the axis A is a substantially rectangular shape.

The third contact plane SF3 is provided on one side of the second pawl 18d in the circumferential direction of the anvil 18. In addition, the fourth contact plane SF4 is provided on the other side of the second pawl 18d in the circumferential direction of the anvil 18. Further, the second contact surface SF2 of the first pawl 30e of the hammer 30 is in contact with the third contact plane SF3 on the substantially entire surface, and the first contact surface SF1 of the first pawl 30e of the hammer 30 is in contact with the fourth contact plane SF4 on the substantially entire surface.

In addition, a width size of the second pawl 18d in a direction along the circumferential direction on the radially outer side of the anvil 18 is set to about 10.0 mm. Namely, the second pawl 18d is designed to have the slightly smaller width size than the first pawl 30e. Accordingly, the strength of the second pawl 18d is sufficiently secured, and the first pawl 30e of the hammer 30 enters between the second pawls 18d neighboring in the circumferential direction of the anvil 18 with a margin.

Here, in a state where the first pawl 30e of the hammer 30 and the second pawl 18d of the anvil 18 are engaged with each other in the forward rotation direction (screw-tightening direction), the first contact surface SF1 of the first pawl 30e and the fourth contact plane SF4 of the second pawl 18d are in contact with each other on the substantially entire surface. Further, when the hammer 30 performs a striking operation (during the striking), the two first contact surfaces SF1 and the two fourth contact planes SF4 impact each other and are opened substantially at the same time. Since the two first pawls 30e and the two second pawls 18d are provided in the hammer 30 and the anvil 18, respectively, as described above, the number of times of striking (simultaneous striking) is two when the hammer 30 and the anvil 18 relatively rotate once. Namely, when the hammer 30 rotates by 180 degrees with respect to the anvil 18, the pair of first pawls 30e strikes the pair of second pawls 18d at the same time. When such striking is counted as once, the simultaneous striking is performed twice in one rotation.

Note that, when the forward/reverse switching lever 16 (see FIG. 2) is operated, the first pawl 30e of the hammer 30 and the second pawl 18d of the anvil 18 are engaged with each other in the reverse rotation direction (screw-loosening direction). Therefore, the second contact surface SF2 of the first pawl 30e and the third contact plane SF3 of the second pawl 18d are in contact with each other on the substantially entire surface. Accordingly, the striking force is applied in the reverse rotation direction, and it is possible to loosen a tightened screw (not illustrated).

As illustrated in FIG. 6, when the rising of the number of rotations is compared between a rotating body with low inertia L and a rotating body with high inertia H in the case of a driving source having the same output, the rotating body with the low inertia L rises faster than the rotating body with the high inertia H. Accordingly, with respect to the difference in the number of rotations between the rotating body with the low inertia L and the rotating body with the high inertia H, the difference in the number of rotations (rL1−rH1) after the elapse of a time t1 immediately after the start of rotation is larger than the difference in the number of rotations (rL2−rH2) after the elapse of a time t2 which is longer than the time t1 ((rL1−rH1)>(rL2−rH2)). Thereafter, both the rotating bodies reach the maximum number of rotations (Max) of the driving source after the elapse of a time t3 which is still longer than the time t2.

Since the striking mechanism SM1 according to the present invention has the three-pawl specification, a striking interval thereof is narrower (the interval of 120 degrees) than that of the striking mechanism SM2 having the two-pawl specification according to the comparative example. Therefore, striking is started at the time t1 at which the number of rotations of each of the rotor 12b and the spindle 26 has not sufficiently risen in the striking mechanism SM1. On the other hand, since the striking interval of the striking mechanism SM2 is wider (the interval of 180 degrees) than that of the striking mechanism SM1, striking is started at the time t2 at which the number of rotations of each of the rotor 12b and the spindle 26 has sufficiently risen.

As illustrated in FIG. 7, the striking mechanism SM2 having the two-pawl specification (comparative example) starts the striking at the time t2, and thereafter, the screw tightening work is completed when the number of times of striking becomes “five times” as illustrated in (1)→(2)→(3)→(4)→(5) in the drawing. Namely, a time (t4−t2) taken between the time t2 at which the striking mechanism SM2 starts the striking and a time t4 at which the number of times of striking becomes “five times” is a striking work time of the striking mechanism SM2.

Here, since the striking mechanism SM2 starts the striking at the time t2 as illustrated in FIG. 6, the number of rotations of the rotor 12b and the number of rotations of the spindle 26 (the rotating bodes) become values close to each other (rL2≈rH2) in a fast region (High) regardless of the low inertia L and the high inertia H. Namely, an influence depending on the difference in inertia between the rotating bodies is small in the striking mechanism SM2, and the striking intervals become substantially equal to each other (t2L≈t2H) between the case of the low inertia L shown by the solid line and the case of the high inertia H shown by the broken line as illustrated in FIG. 7. Therefore, the difference in tightening speed hardly occurs in the striking mechanism SM2 regardless of the magnitude of the total inertia TI as illustrated in a characteristic (small inclination of the graph) of the “two-pawl specification” shown by the broken line in FIG. 9.

In this manner, the striking mechanism SM2 has a merit that the difference hardly occurs in the tightening speed even when the magnitude of the total inertia TI changes. Meanwhile, there is a demerit that the work efficiency is poor because the striking work time (t4−t2) is relatively long.

On the contrary, as illustrated in FIG. 8, the striking mechanism SM1 having the three-pawl specification (present invention) starts the striking at the time t1, and the screw tightening work is completed when the number of times of striking becomes “five times” as illustrated in (1)→(2)→(3)→(4)→(5) in the drawing. Namely, a time (t5−t1) taken between the time t1 at which the striking mechanism SM1 starts the striking and a time t5 at which the number of times of striking becomes “five times” is a striking work time of the striking mechanism SM1.

Here, since the striking mechanism SM1 starts the striking at the time t1 as illustrated in FIG. 6, the number of rotations of the rotor 12b and the number of rotations of the spindle 26 become values different from each other (rL1>rH1) in a slow region (Low) in the cases of the low inertia L and the high inertia H. Namely, the influence depending on the difference in inertia between the rotating bodies is large in the striking mechanism SM1 as compared to the striking mechanism SM2, and the striking intervals also become different from each other (t3L<t3H) between the case of the low inertia L shown by the solid line and the case of the high inertia H shown by the broken line as illustrated in FIG. 8. Therefore, the difference in tightening speed also occurs in the striking mechanism SM1 depending on the magnitude of the total inertia TI as illustrated in a characteristic (large inclination of the graph) of the “three-pawl specification” shown by the solid line in FIG. 9.

As described above, the striking mechanism SM1 has a demerit that the difference occurs in the tightening speed depending on the magnitude of the total inertia TI. Thus, the total inertia TI (converted in terms of the rotation axis of the spindle 26) of the inertia RI of the rotor 12b and the inertia SI of the spindle 26 is set to “276.988 kg·mm²” which is not more than “300 kg·mm²” as illustrated in FIG. 9 in order to improve the work efficiency by shortening the striking work time (t5−t1) of the striking mechanism SM1 than the striking work time (t4−t2) of the striking mechanism SM2.

Here, a boundary value “300 kg·mm²” of the total inertia TI illustrated in FIG. 9 is a boundary at which the work efficiency (tightening speed) of the striking mechanism SM1 (the present invention) and the work efficiency of the striking mechanism SM2 (comparative example) are reversed. Namely, when the total inertia TI is equal to or less than the boundary value “300 kg·mm²”, the tightening speed of the striking mechanism SM1 is faster than the tightening speed of the striking mechanism SM2, and it is possible to achieve the improvement of the work efficiency.

Also, it is possible to increase the tightening speed by further decreasing the total inertia TI as illustrated in FIG. 9, and eventually it is possible to further improve the work efficiency. In the present embodiment, the inner rotor brushless motor is particularly employed as the electric motor 12 (the driving source) in order to set the total inertia TI to be equal to or less than the boundary value “300 kg·mm²”. Namely, the inertia can be reduced by employing the inner rotor brushless motor as compared to, for example, a brush-equipped electric motor. To be specific, a rotor wound with a coil, a commutator and others are included in the rotating body in the brush-equipped electric motor, and thus, there is a structural limit for the decrease of the inertia.

As described above, it is possible to set the striking interval to the “interval of 120 degrees”, which is shorter than that in the related art, by providing the three first pawls 30e of the hammer 30 and the three second pawls 18d of the anvil 18 in the impact driver 10 according to the present embodiment. When the total inertia TI obtained by sum of the inertia RI of the rotor 12b and the inertia SI of the spindle 26 is set to a low value of not more than “300 kg·mm²” when being converted in terms of the rotation axis of the spindle 26, it is possible to sufficiently accelerate the rotor 12b and the spindle 26 and to improve the work efficiency. Namely, in the impact driver 10 according to the present embodiment, it is possible to increase the number of times of striking by setting the total inertia TI to the low inertia and respectively providing the three pawls. As illustrated in FIG. 10, it is possible to set the number of times of striking to “4,000 times/minute or larger (for example, 4,500 times/minute)” in the present embodiment. Accordingly, it is possible to increase the screw tightening speed. In addition, it is possible to decrease shaking of the hand per striking by increasing the number of times of striking, and thus, it is also possible to suppress a come-out phenomenon in which the tool tip is detached from a screw even in the case of tightening a long screw. Accordingly, it is possible to increase the screw tightening speed and to improve the work efficiency. Note that comparative examples A to D illustrated in FIG. 10 are examples in which the number of times of striking is “smaller than 4,000 times/minute” (3,200 times/minute to 3,500 times/minute), and the screw tightening speed thereof is slower and the stable operation thereof is more difficult as compared to the impact driver 10 according to the present embodiment.

In addition, since the brushless motor is used as the electric motor 12 in the impact driver 10 according to the present embodiment, it is possible to suppress the inertia of the rotating body to be lower than that of the brush-equipped electric motor. Therefore, it is possible to further improve the work efficiency. Further, since the brushless motor is employed, maintenance such as replacement of a brush is unnecessary.

In addition, since the inner rotor brushless motor is used as the electric motor 12 in the impact driver 10 according to the present embodiment, it is possible to decrease a diameter size of the rotor 12b and to further suppress the inertia. Therefore, it is possible to further improve the work efficiency.

The present invention is not limited to the above-described embodiment, and it is a matter of course that various modifications can be made in a range not departing from a gist thereof. For example, the impact tool of the present invention may include an impact wrench or the like in addition to the impact driver 10 described above. In addition, the impact tool of the present invention may include a structure in which power of an AC power source can be supplied to the electric motor 12 without using the battery pack 11. Further, the impact tool of the present invention may include a structure in which the power to be supplied to the electric motor 12 can be switched between the power of the battery pack 11 and the power of the AC power source.

In addition, the driving source of the present invention may include a pneumatic motor, a hydraulic motor and the like in addition to the electric motor 12 described above. Further, examples of the electric motor 12 may include an outer rotor brushless motor and even a brush-equipped electric motor if it is possible to reduce the inertia. In addition, the impact tool of the present invention may include a structure in which a tool tip is attached to an anvil via a socket or an adapter in addition to the structure in which the tool tip 17 is directly attached to the anvil 18.

Next, second and third embodiments of the present invention will be described in detail with reference to the drawings (FIGS. 1 to 5 and 10 to 15).

In the first embodiment, it is possible to make the screw tightening speed of the striking mechanism SM1 (the three-pawl specification) faster than that of the striking mechanism SM2 (the two-pawl specification) and to improve the work efficiency. Meanwhile, it is possible to suppress the come-out in an initial stage of screw tightening in both the striking mechanisms SM1 and SM2 and to achieve the fast screw tightening in the second and third embodiments. Hereinafter, an operation of the impact driver 10 according to the second embodiment will be described in detail with reference to the drawings.

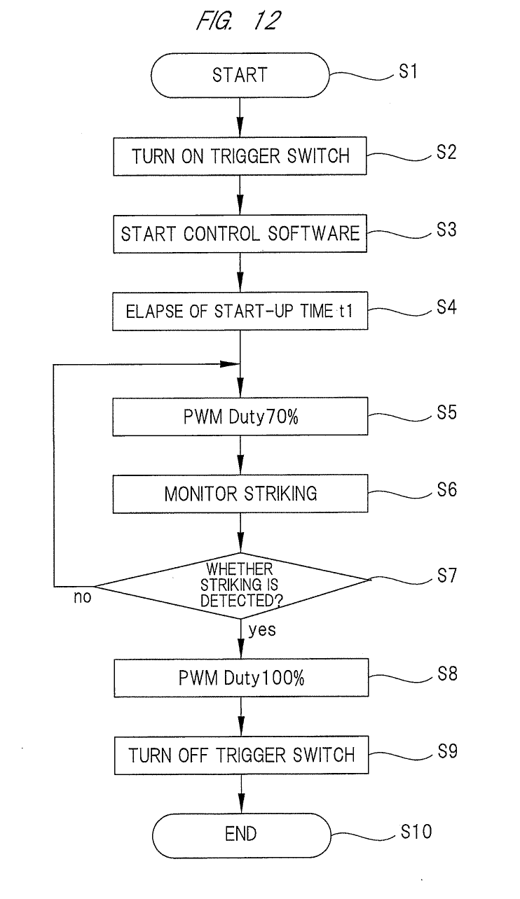

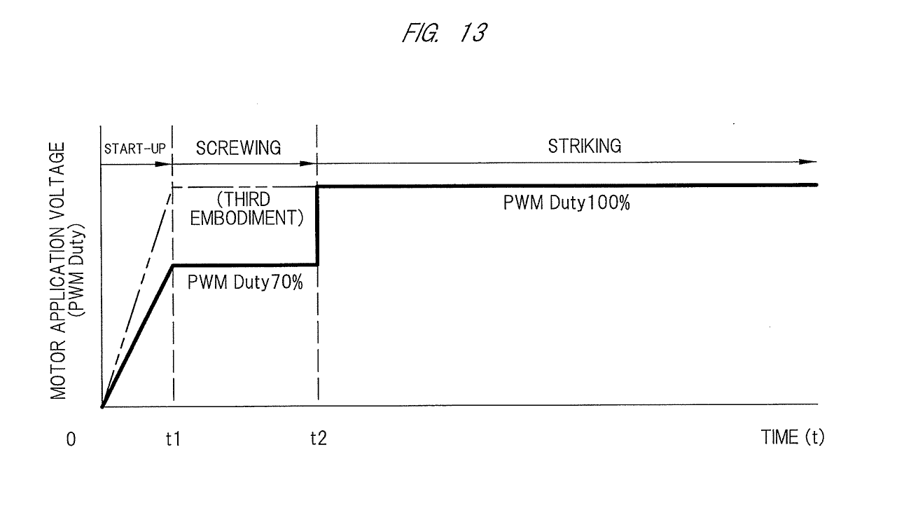

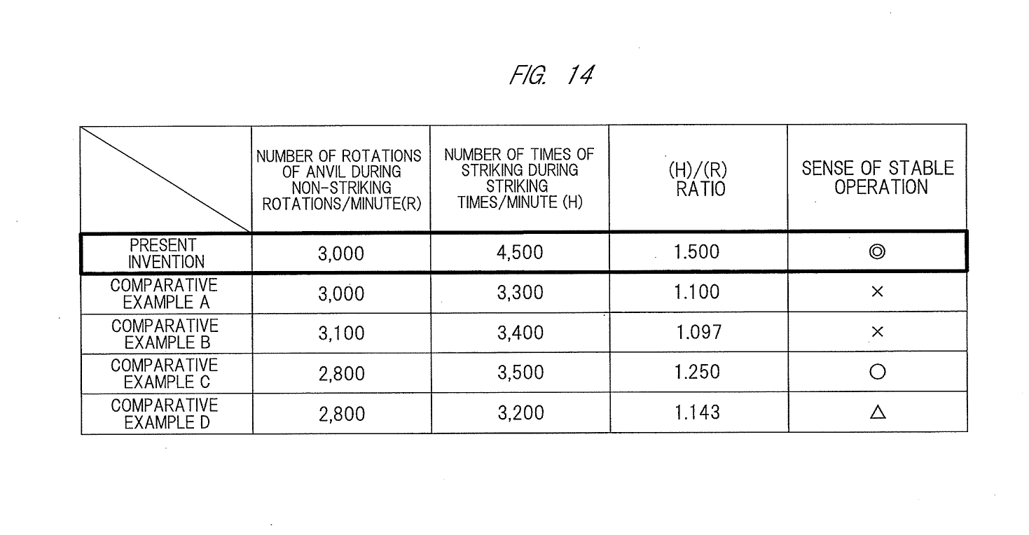

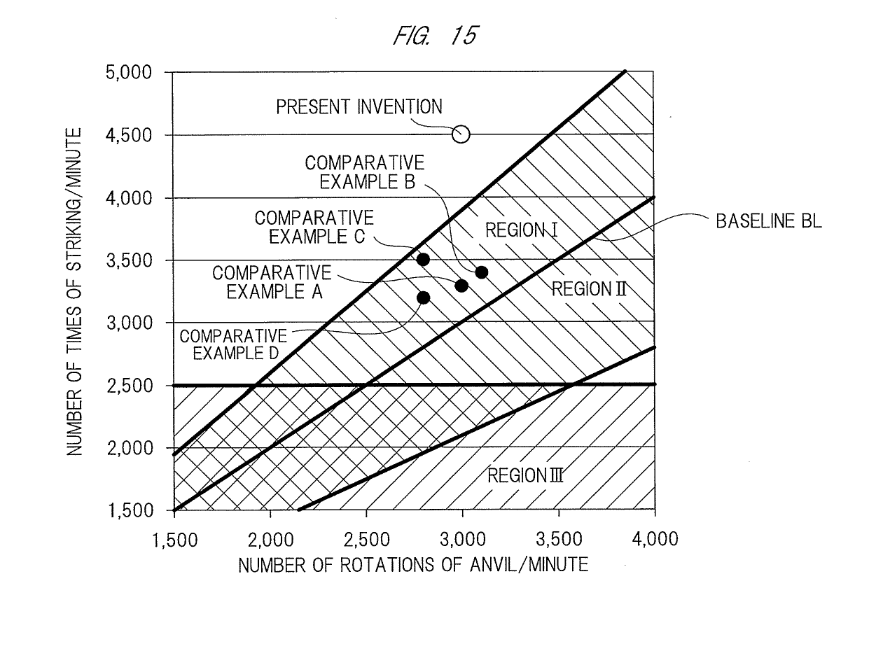

FIG. 10 illustrates a graph focusing on the number of times of striking for comparing the present invention and the four comparative examples A to D, FIG. 11 illustrates an electric circuit block diagram of the impact tool of FIG. 1, FIG. 12 illustrates a flowchart for describing the operation of the impact tool of FIG. 1, FIG. 13 illustrates a timing chart for describing the operation of the impact tool of FIG. 1, FIG. 14 illustrates a table for comparison between the present invention and the four comparative examples A to D, and FIG. 15 illustrates a graph for comparison between the present invention and the four comparative examples A to D.

As illustrated in FIG. 12, a voltage signal from the trigger switch 15 is input to the switch operation detection circuit 42g and the application voltage setting circuit 42h by the operation of the trigger switch 15 performed by the worker in Step S1. Accordingly, the start data from the switch operation detection circuit 42g is input to the computation unit 42a. In Step S2, the operation amount data from the application voltage setting circuit 42h is input to the computation unit 42a, and the computation unit 42a recognizes that the trigger switch 15 is turned on, that is, the screw tightening work is started as the operation amount of the trigger switch 15 by the worker increases. Accordingly, control software of the controller 40 is started, and the control of the impact driver 10 is started in Step S3. Note that the control software is stored in advance in a ROM or the like (not illustrated) which is provided inside the computation unit 42a.

In Step S4, a start-up process of the impact driver 10 is executed until a start-up time t1 elapses. To be specific, a process of gradually increasing the duty ratio (PWM Duty) of the PWM signal is executed by the computation unit 42a from the time 0 to t1 as illustrated in FIG. 13. Accordingly, the voltage applied to the electric motor 12 gradually increases, so that the abrupt rotation of the tool tip 17 is suppressed. Thus, the tool tip 17 is prevented from being lifted and detached from a screw (not illustrated), that is, the come-out is prevented. In addition, it is also possible to suppress inrush current at the time of start-up of the electric motor 12.

In Step S5, the computation unit 42a sets the duty ratio of the PWM signal to “70%” along with the elapse of the start-up time t1. Accordingly, the screwing is started in a state where a load to the tool tip 17 (see FIG. 2) is low. Here, the case in which the screw is screwed into a wood (not illustrated) will be described as an example in the present embodiment. Note that the screwing is the work in which a tip portion of the screw can be screwed into the wood by only a rotational force of the electric motor 12 (see FIG. 2) without depending on striking of the hammer 30 (see FIG. 3). Further, in Step S5, the number of rotations of the anvil 18 in the case in which the duty ratio of the PWM signal is “70%” and the hammer 30 is in the non-striking state (from the time t1 to t2 in FIG. 6) is set to “3,000 rotations/minute” as illustrated in FIG. 7.

In Step S6, input of a striking state signal from the striking impact detection circuit 42j is monitored by the computation unit 42a. Next, it is determined whether the striking of the hammer 30 is detected by the computation unit 42a in Step S7. Further, when it is determined that the striking state signal is output from the striking impact detection circuit 42j as the screwing amount of the screw into the wood increases and the load to the tool tip 17 increases, that is, it is determined that the striking of the hammer 30 is started (determined to “yes”), the process proceeds to Step S8. On the other hand, when it is determined that the striking of the hammer 30 has not been started yet (determined to “no”) in Step S7, the process returns to Step S5, and the electric motor 12 is continuously driven while setting the duty ratio of the PWM signal to “70%”.

As illustrated in FIG. 12, the computation unit 42a sets the duty ratio of the PWM signal to “100%” along with the detection of the striking of the hammer 30 in Step S8. Accordingly, the application voltage to the electric motor 12 is increased from the time t2, and the number of rotations and the rotational force of the anvil 18 are also increased. Here, since the load to the tool tip 17 is low during the work of the screwing, the number of rotations of the anvil 18 is maintained at “3,000 rotations/minute” even when the duty ratio of the PWM signal is “70%”. On the other hand, since the load to the tool tip 17 is high during the striking of the hammer 30, the number of rotations of the anvil 18 is decelerated to “2,250 rotations/minute” even when the duty ratio of the PWM signal is “1000”. Therefore, when the number of rotations of the anvil 18 is “2,250 rotations/minute” during the striking of the hammer 30, the number of times of striking becomes a doubled value thereof, that is, “4,500 times/minute” (see FIG. 14).

As described above, the number of rotations of the anvil 18 is set to “3,000 rotations/minute” by setting the duty ratio of the PWM signal to “70%” during the non-striking of the hammer 30 in which the load to the tool tip 17 is low in the present embodiment. Accordingly, it is possible to suppress the come-out in which the tool tip 17 is detached from the screw during the screw tightening work, particularly, in the initial stage of the screw tightening (during the screwing), so that the fast screw tightening can be achieved and the screw tightening work can be facilitated. In particular, the present embodiment is optimally applicable to a long wood screw or the like. Meanwhile, the number of times of striking of the hammer 30 is set to “4,500 times/minute” by setting the duty ratio of the PWM signal to “100%” during the striking of the hammer 30 in which the load to the tool tip 17 is high. Therefore, the ratio (H)/(R) between the number of rotations (R) of the anvil 18 during the non-striking of the hammer 30 and the number of times of striking (H) during the striking of the hammer 30 becomes “1:1.5” as illustrated in FIG. 14. Namely, the ratio between the number of rotations (R) and the number of times of striking (H) becomes “1:1.3 or higher” in the present embodiment. When the number of times of striking of the hammer 30 is set to “4,000 times/minute or larger”, it is possible to actually feel that the come-out is less likely to occur. Accordingly, it is possible to decrease shaking of the hand per striking by increasing an impact frequency (the number of times of striking), and thus, the come-out hardly occurs even at the time of tightening a long screw.

Thereafter, when the screwing work of the screw into the wood ends and the operation of the trigger switch 15 by the worker is opened (turned off), input of the voltage signal from the trigger switch 15 to the switch operation detection circuit 42g disappears. Accordingly, the computation unit 42a stops the driving of the electric motor 12 via the control signal circuit 42e (Step S9). Subsequently, the computation unit 42a causes the pair of switching elements 47 for stopping the controller to perform a switching operation via the control signal circuit 42e. Thus, the power supply to the controller 40 is stopped (Step S10).

As described above, the impact driver 10 according to the second embodiment includes the controller 40 that controls the electric motor 12, and the controller 40 increases the application voltage to the electric motor 12 when detecting the striking of the hammer 30. Also, the ratio between the number of rotations (rotation frequency) of the anvil 18 during the non-striking of the hammer 30 and the number of times of striking (impact frequency) during the striking of the hammer 30 is set to “1:1.5” which falls within the range of “1:1.3 or higher”. Accordingly, the ratio between the number of rotations and the number of times of striking according to the second embodiment can be made significantly different from a baseline BL (a ratio is substantially “1:1”) where the number of rotations and the number of times of striking become substantially the same value as illustrated in FIG. 15.

Therefore, when the hammer 30 is transitioned from the non-striking state to the striking state, it is possible to suppress resonance between the rotation frequency and the impact frequency and to suppress the impact driver 10 from greatly vibrating. Accordingly, the more stable operation can be achieved and the sense of operation is evaluated as “C)” in the impact driver 10 according to the second embodiment as illustrated in FIG. 14, and it is possible to acquire the improvement of both the workability and the sense of operation.

Note that “comparative example A” and “comparative example B” relate to an impact driver (according to a conventional example) having a characteristic close to the baseline BL in which a ratio between the number of rotations of an anvil (during non-striking) and the number of times of striking of a hammer (during the striking) is about “1:1” as illustrated in FIGS. 14 and 15. The stable operation is difficult in both the examples, and the sense of operation thereof is evaluated as “x”. In addition, “comparative example C” and “comparative example D” relate to an impact driver having a ratio between the number of rotations and the number of times of striking of “1:1.143” and “1:1.250”, respectively, that is, having a characteristic slightly different from the baseline BL in which a ratio between the number of rotations and the number of times of striking is about “1:1”. Since both “comparative example C” and “comparative example D” have characteristics that the ratio is within a “region I” which does not exceed “1:1.3”, the state of stable operation and the sense of operation are evaluated as “A” and “O”, respectively, which are inferior to the present invention. Note that the range within the “region I” and a “region II” illustrated in FIG. 15 indicates the range in which the number of times of striking is less than 1.3 times the number of rotations.

Further, in the impact driver 10 according to the second embodiment, the impact frequency relative to the rotation frequency is set to a higher value on the side above the “region I” with respect to the baseline BL as the center as illustrated in FIG. 15, and it is thus possible to reduce a fluctuation (shake width) of the main body of the impact driver 10 during the striking of the hammer 30. Further, when the number of times of striking is only focused, the number of times of striking is “4,000 times/minute of larger (4,500 times/minute)” in the present invention, which is larger than the number of times of striking in comparative examples A to D (3,200 times/minute to 3,500 times/minute) as illustrated in FIG. 10. Since it is possible to suppress the shaking of the hand per striking by increasing the number of times of striking in this manner, the come-out hardly occurs even at the time of tightening the long screw. Accordingly, the evaluation becomes “◯”, and it is possible to actually feel that the come-out is less likely to occur. Accordingly, it is possible to easily tighten even the long screw.

Here, even when the impact frequency (number of times of striking) relative to the rotation frequency (number of rotations) is set to a lower value on the side of the “region II” with respect to the baseline BL as the center as illustrated in FIG. 15, it is possible to suppress the above-described resonance. In this case, however, the fluctuation of the main body of the impact driver 10 increases due to a large vibration force of the hammer 30, and thus, it is hardly considered as a desirable measure. In particular, when the number of times of striking is set to a value within a “region III” in which the number of times of striking is “2,500 times/minute” or smaller, the striking efficiency is extremely decreased, and the workability is significantly decreased.

In addition, since the electric motor 12 is configured of the brushless motor in the impact driver 10 according to the second embodiment, it is possible to finely control the electric motor 12. Therefore, it is also possible to perform the control so that the impact frequency is shifted with respect to a resonance frequency of the casing 13 which forms the impact driver 10, for example, and it is thus possible to further reduce the fluctuation of the main body of the impact driver 10.

Next, the third embodiment of the present invention will be described in detail with reference to the drawings.

As illustrated in FIG. 4, the third embodiment is different from the second embodiment in the structure of the striking mechanism SM1, and the same striking mechanism as that of the first embodiment is used. In addition, a difference is that a duty ratio of a PWM signal after elapse of the start-up time t1 is fixed to “100%” and the duty ratio of the PWM signal is not changed thereafter as shown by the two-dot chain line in FIG. 13. Further, another difference is that the striking impact detection circuit 42j and the striking impact detection sensor 43 (see FIG. 11) are not provided because the duty ratio of the PWM signal is not changed using the detection of striking of the hammer 30 as a trigger.

Namely, although the ratio between the number of rotations (rotation frequency) and the number of times of striking (impact frequency) is set to “1:1.5” which falls within the range of “1:1.3 or higher” by controlling the duty ratio of the PWM signal in the above-described second embodiment, the ratio between the number of rotations and the number of times of striking is set to “1:1.3 or higher” by employing the striking mechanism SM1 having the same structure as that of the first embodiment instead of the striking mechanism SM2 of the second embodiment in the third embodiment. The configuration of the striking mechanism SM1 is the same as that of the first embodiment, and thus, the descriptions thereof will be omitted.

Also in the third embodiment, the ratio between the number of rotations (rotation frequency) of the anvil 18 during non-striking of the hammer 30 and the number of times of striking (impact frequency) during the striking of the hammer 30 can be set to “1:1.3 or higher” like in the second embodiment. Namely, in the third embodiment, it is possible to obtain the number of times of striking three times as large as the decreased number of rotations of the anvil 18 in the transition of the hammer 30 from the non-striking state to the striking state even if the duty ratio of the PWM signal is fixed to “100%”. Accordingly, it is possible to set the ratio between the number of rotations and the number of times of striking to “1:1.3 or higher”. Therefore, parts such as the striking impact detection sensor 43 can be omitted and the control logic can be simplified in the third embodiment as compared to the second embodiment.

Further, since it is unnecessary to perform fine control of the electric motor 12 such as the change of the duty ratio of the PWM signal in the third embodiment, an inexpensive brush-equipped motor can be employed instead of a brushless motor.

The present invention is not limited to the respective embodiments described above, and it is a matter of course that various modifications can be made in a range not departing from a gist thereof. For example, the ratio between the number of rotations of the anvil during the non-striking of the hammer and the number of times of striking during the striking of the hammer is set to “1:1.3 or higher” in the respective embodiments described above, but the present invention is not limited thereto. For example, the ratio between the number of rotations and the number of times of striking may be set to “1:1.3”, and in this case, secondary resonance can be made less likely to occur because “1” and “1.3” can be set to be high as common multiples.

Also, the impact tool of the present invention may include an impact wrench or the like in addition to the impact driver 10 described above. In addition, the impact tool of the present invention may include a structure in which power of an AC power source can be supplied to the electric motor 12 without using the battery pack 11. Furthermore, the impact tool of the present invention may include a structure in which the power to be supplied to the electric motor 12 can be switched between the power of the battery pack 11 and the power of the AC power source.

Further, the driving source of the present invention may include an engine, a pneumatic motor, a hydraulic motor and the like in addition to the electric motor 12 described above. The engine is a power source that converts heat energy generated by burning fuel into kinetic energy, and examples thereof may include a gasoline engine, a diesel engine and a liquefied petroleum gas engine. In addition, the impact tool of the present invention may include a structure in which a tool tip is attached to an anvil via a socket or an adapter in addition to the structure in which the tool tip 17 is directly attached to the anvil 18.

### REFERENCE SIGNS LIST

10 impact driver (impact tool)
11 battery pack
12 electric motor (driving source, brushless motor)
12a stator
12b rotor (first rotating body)
12c coil
13 casing
14 rotation shaft
15 trigger switch
16 forward/reverse switching lever
17 tool tip
18 anvil (output member, rotating body)
18a holding hole
18b mounting hole
18c main body
18d second pawl
19 sleeve
20 attaching/detaching mechanism
21 decelerator
22 sun gear
23 ring gear
24 planetary gear
25 carrier
26 spindle (second rotating body, rotating body)
26a shaft
26b spindle cam
27 holder member
28 bearing
29 steel ball
30 hammer (striking member)
30a hammer cam
30b main body
30c mounting hole
30d opposing plane (opposing surface)
30e first pawl
31 annular plate
32 spring
33 stopper
A axis
SF1 first contact plane
SF2 second contact plane
SF3 third contact plane
SF4 fourth contact plane
SM1 striking mechanism (three-pawl specification)
SM2 striking mechanism (two-pawl specification)

1. An impact tool that applies a rotational force and a striking force to a tool tip, the impact tool comprising:
a driving source including a first rotating body;
a second rotating body rotated by the first rotating body;
an output member provided with the tool tip;
a striking member which converts a rotational force of the second rotating body into a rotational force and a striking force of the output member;
three first pawls disposed side by side in a circumferential direction in the striking member on a side closer to the output member; and
three second pawls disposed side by side in a circumferential direction in the output member on a side closer to the striking member and engaged with the first pawls, respectively,
wherein a total inertia obtaining by sum of inertia of the first rotating body and inertia of the second rotating body is set to be equal to or less than 300 kg·mm² when being converted in terms of a rotation axis of the second rotating body.

2. The impact tool according to claim 1,
wherein the first pawls and the second pawls are disposed at an interval of 120 degrees along the circumferential direction of each of the striking member and the output member.

3. The impact tool according to claim 1,
wherein the number of times of striking of the striking member is set to 4,000 times/minute or larger.

4. An impact tool that applies a rotational force and a striking force to a tool tip, the impact tool comprising:
an electric motor including a rotor;
a spindle rotated by the rotor;
an anvil provided with the tool tip; and
a hammer which converts a rotational force of the spindle into a rotational force and a striking force of the anvil,
wherein the number of times of striking of the hammer is set to 4,000 times/minute or larger.

5. The impact tool according to claim 4, further comprising:
three first pawls disposed side by side in a circumferential direction in the hammer on a side closer to the anvil; and
three second pawls disposed side by side in a circumferential direction in the anvil on a side closer to the hammer and engaged with the first pawls, respectively.

6. The impact tool according to claim 4,
wherein a total inertia obtaining by sum of inertia of the rotor and inertia of the spindle is set to be equal to or less than 300 kg·mm² when being converted in terms of a rotation axis of the spindle.

7. An impact tool comprising:
a motor;
an anvil rotated by the motor to rotate a tool tip; and
a hammer applying a striking force to the anvil,
wherein a controller which controls the motor is provided, and
the controller is configured to increase a voltage applied to the motor when detecting striking of the hammer.

8. The impact tool according to claim 7,
wherein the number of times of striking of the hammer is set to 4,000 times/minute or larger.

9. The impact tool according to claim 7,
wherein first pawls are provided in the anvil,
second pawls are provided in the hammer,
the striking force is generated when the first pawls and the second pawls impact each other in a rotation direction, and
the number of the first pawls and the number of the second pawls are three, respectively.

10. An impact tool comprising:
a rotating body which rotates a tool tip; and
a striking member which applies a striking force to the tool tip,
wherein a ratio between the number of rotations of the rotating body during non-striking of the striking member and the number of times of striking during striking of the striking member is 1:1.3 or higher.

11. The impact tool according to claim 10,
wherein the number of times of striking is 4,000 times/minute or larger.

12. The impact tool according to claim 10,
wherein a driving source of the rotating body is a brushless motor,
a controller which controls the brushless motor is provided, and
the controller increases a voltage to be applied to the brushless motor when detecting striking of the striking member.

13. The impact tool according to claim 10,
wherein first pawls are provided in the rotating body,
second pawls are provided in the striking member,
the striking force is generated when the first pawls and the second pawls impact each other in a rotation direction, and
the number of the first pawls and the number of the second pawls are three, respectively.

14. An impact tool comprising:
an anvil including first pawls and rotating a tool tip; and
a hammer including second pawls which impact the first pawls in a rotation direction and applying a striking force generated by the impact to the anvil,
wherein the number of the first pawls and the number of the second pawls are three, respectively, and
a ratio between the number of rotations of the anvil during non-striking of the hammer and the number of times of striking during striking of the hammer is set to 1:1.3 or higher.

15. The impact tool according to claim 14,
wherein the number of times of striking is 4,000 times/minute or larger.
